(19) United States
(12) Patent Application Publication
(10) Pub. No.: US 2014/0100854 A1
(43) Pub. Date: Apr. 10, 2014

(54) SMART SWITCH WITH VOICE OPERATED FUNCTION AND SMART CONTROL SYSTEM USING THE SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/014,326

(22) Filed: Aug. 29, 2013

(30) Foreign Application Priority Data
Oct. 9, 2012 (CN) 201210378589X

(51) Int. Cl. G10L 15/22

(52) U.S. Cl. CPC G10L 15/22
USPC 704/275

(57) ABSTRACT

A smart switch applied to a smart control system in a smart house, includes a storage, a voice input unit configured to receive vocal commands and convert the vocal commands to electronic data, and a remote control unit. A processor unit which includes a voice identifying module, a determining module, and a control module is also included. The smart switch recognizes a voice command and sends a remote control command to the target electronic devices, thereby controlling the electronic devices to execute an operation. A smart control system is also provided.

### BACKGROUND

1. Technical Field

The present disclosure relates to smart home technology, and particularly to a smart switch with voice operated function and a smart control system employing the smart switch.

2. Description of Related Art

A manual switch may be arranged on a wall or floor of the house for turning on/off the power of electronic devices. Some switches also include sockets and indicator lights configured to indicate power states. However, such function of the switch is only a single function.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view showing a smart control system, according to a first exemplary embodiment.

FIG. 2 is a schematic view showing a smart control system, according to a second exemplary embodiment.

FIG. 3 is a block diagram of a smart control system, according to an exemplary embodiment.

FIG. 4 is a schematic view showing a smart control system using a smart switch according to an exemplary embodiment.

FIG. 5 is a block diagram of a smart control system, according to another exemplary embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

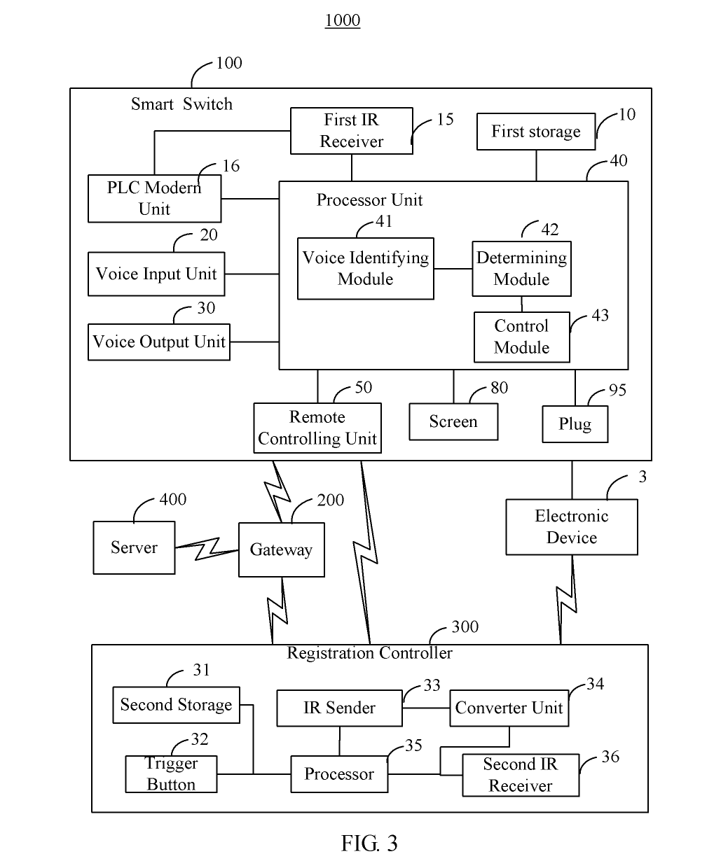

Referring to FIG. 3, a smart control system 1000 in accordance with an exemplary embodiment is provided. The smart control system 1000 includes a smart switch 100, a gateway 200, a registration controller 300, and plugged into the smart switch 100. The electronic devices 3 can be home appliances. The smart switch 100 is connected to the gateway 200 by wired connections or wireless connections. The wired connections may be Power Line Communication (hereinafter PLC), Optical Fiber Power Line Communication (hereinafter OPLC), wired internet communication, coaxial cable communication, telephone line communication, or other communication technologies. The registration controller 300 is arranged in each room of a house employing the smart control system 100, and are connected to the gateway 200 via the wired or wireless connections.

User can use the registration controller 300 to control the smart switch 100 in a room in which the registration controller 300 is located, to automatically register on the gateway 200. In detail, the smart switch 100 sends a unique identification code (UID) to the gateway 200, to be registered in the gateway 200. In an embodiment, the smart switch 100 includes a number of sockets, each of the sockets is assigned with a UID, the smart switch 100 further sends the UIDs of the sockets to the gateway 200, thereby the sockets also being registered on the gateway 200. The registration controller 300 includes a UID stored therein.

The smart switch 100 recognizes a voice command and sends an equivalent remote control command to the electronic devices 3, thereby controlling the electronic devices 3 to execute an operation. The smart switch 100 includes a first storage 10, a voice input unit 20, a voice output unit 30, a processor unit 40 and a remote controlling unit 50. The first storage 10, the voice input unit 20, the voice output unit 30, and the remote controlling unit 50 are connected to the processor unit 40.

The first storage 10 stores the UIDs of the electronic devices 3, the names of the electronic devices 3, a one-to-one relationship between the UIDs of the electronic devices 3 and the names of the electronic devices 3, the voice commands, the remote control commands corresponding to each voice command, and the one-to-one relationship between voice commands and the remote control commands. The voice commands are pre-recorded by a user and stored in the first storage 10.

The smart switch 100 of the smart control system 1000 recognizes the voice command, and sends the corresponding remote control command to the electronic devices 3. The remote control command may be a turn on/off command, a log off, a shutdown or a restart command, or other command The electronic device 3 executes a corresponding operation according to the command sent by the smart switch 100, for example, the electronic devices 3 executes a power on/off operation according to the turn on/off command, and executes an operation of logging off the OS according to the log off command.

In this embodiment, the voice input unit 20 is a microphone configured to receive sounds made by a user. The sound of the user's voice is converted to electronic data. The voice output unit 30 is a speaker. The processor unit 40 includes a voice identifying module 41, a determining module 42, and a control module 43.

The voice identifying module 41 identifies the electronic data converted by the voice input unit 20, and extracts a voice command and the name of the target electronic device 3. The determining module 42 obtains the UID of the target electronic device 3 according to the one-to-one relationship between the UIDs of the electronic devices 3 and the names of the electronic devices 3, and obtains the remote control command corresponding to the extracted voice command according to the one-to-one relationships between the voice commands and the remote control commands stored in the first storage 10. The control module 43 controls the remote controlling unit 50 to send the remote control command to the target electronic device 3. In this embodiment, the remote controlling unit 50 is an infrared device.

In an embodiment, the determining module 42 further determines whether or not a same voice command is stored in the first storage 10, compared with the extracted voice command. If yes, the determining module 42 obtains the UID of the target electronic device 3 and the remote control command corresponding to the extracted voice command. If not, the control module 43 controls the voice output unit 30 to output a first sound to warn a user that the smart switch 100 cannot recognize a voice command.

In other embodiments, when the determining module 42 determines that there is no existing voice command stored in the first storage 10, compared with the extracted voice command, the control module 43 controls the voice output unit 30 to output a second sound to warn a user to save a new voice command, for example, the second sound is a spoken and audible sentence of “Unknown voice command, would you like to save as a new voice command⁷” The control module 43 saves the sound of a new command as a new voice command in the first storage 10, when a confirmation of new voice command is received by the voice input unit 20. The confirmation is the spoken sound of the word “yes” or “good.” User also can assign a remote control command to the new voice command.

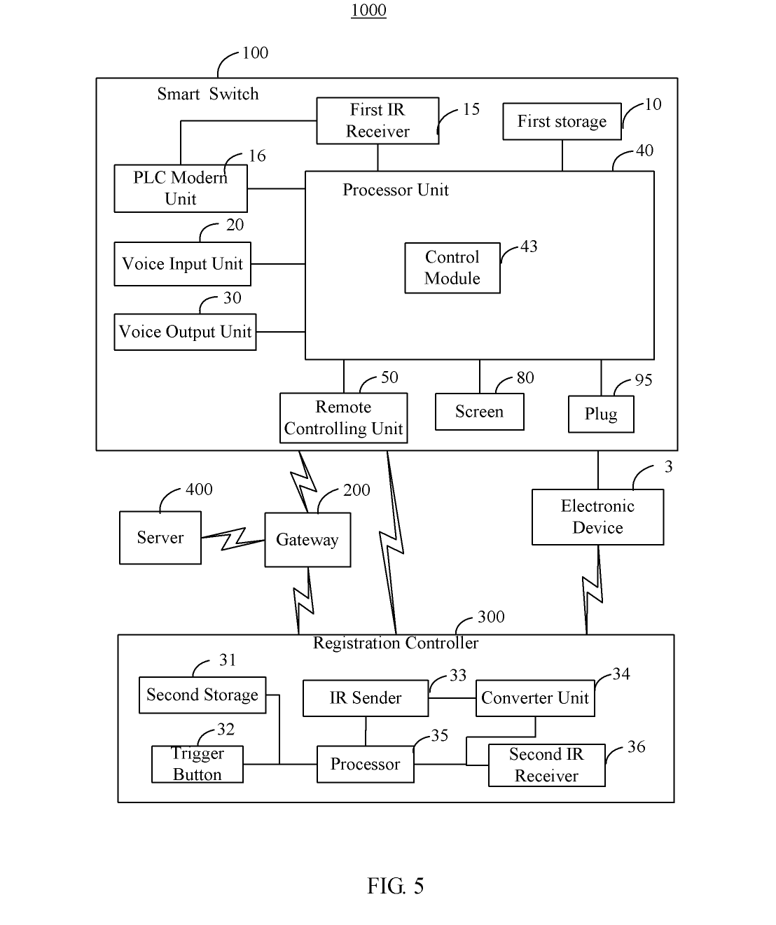

In other embodiments, as shown in FIG. 5, the voice identifying module 41 and the determining module 42 are defined in the gateway 200. The gateway 200 is connected to a cloud voice database, the voice identifying module 41 identifies the electronic data representing the voice command via the cloud voice database, to thereby increase accuracy of identification.

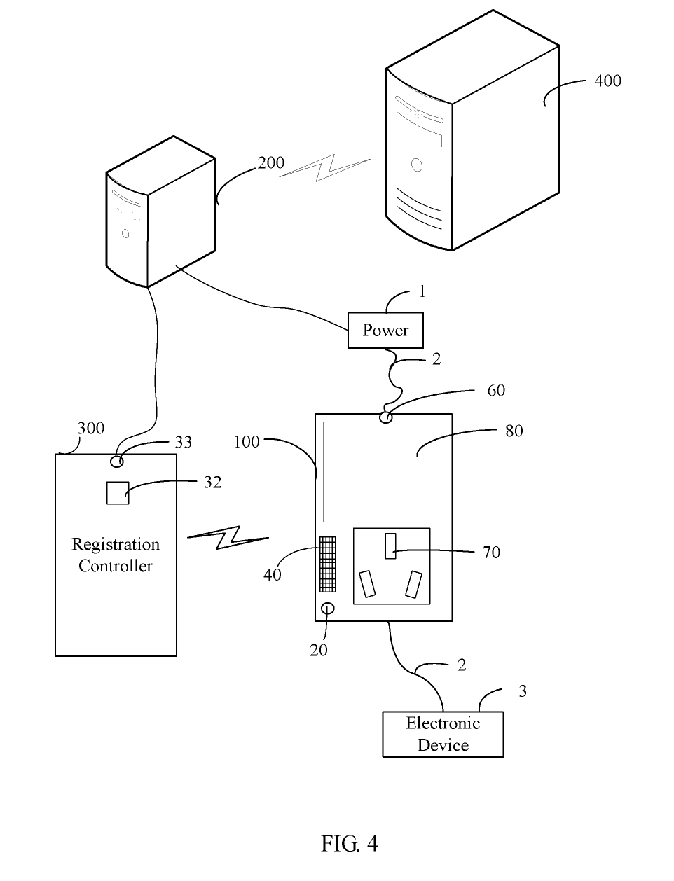

Referring to FIG. 4, the smart switch 100 includes at least one socket 70 configured to connect to the plug of the electronic device 3. The socket 70 can be a three-phase or two-phase socket. In another embodiment, the smart switch 100 is a button switch or a rocker switch, without a socket. The electronic devices 3 can be fridges, air-conditioners, computers, fans, TVs, lamps, micro wave ovens, and the like.

The smart switch 100 further includes a screen 80 configured to display instantaneous information of the electronic devices 3 which are downstream of the smart switch 100. The screen 80 can be an LCD, an electronic paper display, an LED display, a touch display, or the like. The one-to-one relationship between the UIDs of the electronic devices 3 and the names of the electronic devices 3, and the one-to-one relationships between the voice commands and the remote control commands are stored in the server 400.

As shown in FIG. 3 and FIG. 5, the smart switch 100 further includes a plug 95 configured to connect the smart switch 100 to the power source, thus connecting the power supply and the electronic devices 3.

User can use the registration controller 300 to control the smart switch 100 in the room in which the registration controller 300 is located, to automatically register on the gateway 200. In detail, the smart switch 100 send a UID to the gateway 200, to register on the gateway 200. The smart switch 100 can include a number of sockets, each of the sockets is assigned with a UID, the smart switch 100 further sends the UIDs of the sockets to the gateway 200, thereby the sockets being registered on the gateway 200. The registration controller 300 also includes a UID stored therein. A registration process of how the smart switch 100 can register on the gateway 200 follows.

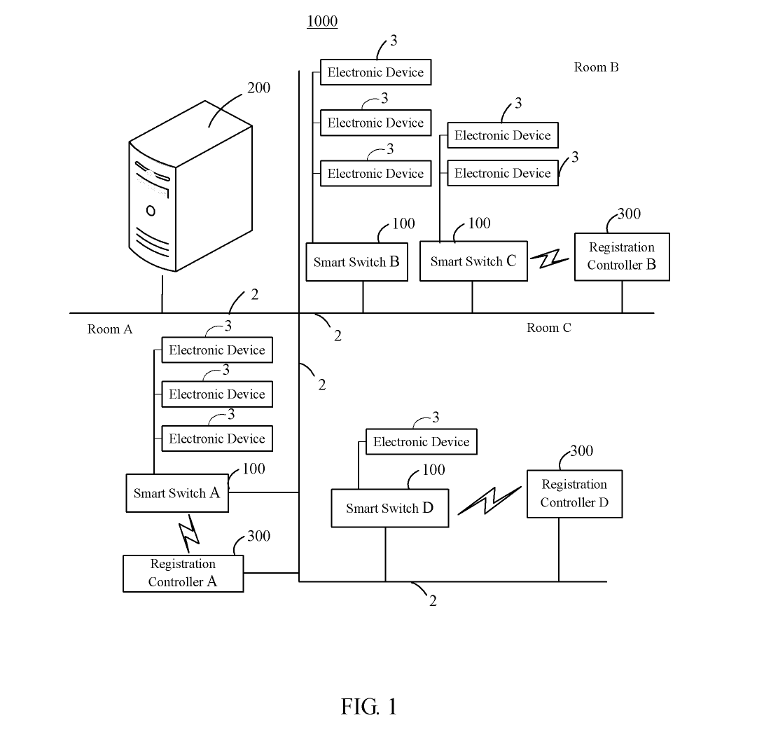

Referring to FIG. 1, the gateway 200, a number of the smart switches 100 and the registration controllers 300 are connected to the power line 2 (or optical fiber power line), and communicate with each other via PLC (or OPLC). In this embodiment, the smart switches 100 include a smart switch A 100 100, a smart switch B 100, a smart switch C 100 and a smart switch D 100. The registration controllers 300 include a registration controller A 300 300, a registration controller B 300 300 and a registration controller D 300. The smart switch A 100 and the registration controller A 300 are located in a room A, the smart switch B 100, the smart switch C 100, and the registration controller B 300 300 are located in a room B. The smart switch D 100 and the registration controller D 300 are located in a room C. The gateway 200 can communicate with all devices connected on the power line 2 (or optical fiber power line) via PLC (or OPLC).

The smart switch 100 further includes a first IR receiver 15 configured to receive IR signals sent by the registration controller 300, and a PLC modem unit 16. The PLC modem unit 16 receives and decodes the data transmitted on the power line 2, the PLC modem unit 16 also encodes and forwards data to the gateway 200 via the power line 2, thereby establishing communication between the smart switch 100 and the gateway 200. In other embodiments, the first IR receiver 15 can be a receiver employing other wireless communication technologies.

Referring to FIG. 3, the registration controller 300 includes a second storage 31, a trigger button 32, an IR sender 33, a converter unit 34, a processor 35 and a second receiver 36.

The registration controller 300 needs to be connected to the gateway 200, before the smart switch 100 can register on the gateway 200. To connect the registration controller 300, the registration controller 300 is located within the communication range of the gateway 200, and a coupling program is run on the smart gateway 20. Then, the smart gateway 20 establishes communication with the registration controller 300, and sends its UID and a secret code to the registration controller 300 wirelessly. The registration controller 300 receives and saves the UID of the gateway 200 and the secret code into the second storage 31. The registration controller 300 further sends its UID to the gateway 200 wirelessly, the gateway 200 receives and saves the UID of the registration controller 300, to finish the coupling process. In this embodiment, the registration controller 300 receives the UID of the gateway 200 and the secret code via the second receiver 36, and sends the UID of the registration controller 300 to the gateway 200 via the IR sender 33. In this embodiment, the secret code is the UID of the gateway 200 or which is input by the user. The secret code is configured to encode or decode the data transmitted between the gateway 200 and the registration controller 300, thus preventing unauthorized user from reading the data. In other embodiments, the gateway 200 and the registration controller 300 can communicate via BLUETOOTH, Z-WAVE, NFC, ZIGBEE, WIFI, or other communication technologies.

If user wants to register the smart switch 100 on the gateway 200, user should locate the connected registration controller 300 in the room containing the smart switches 100 which need to be registered, and run a registering program on the smart gateway 200.

For example, the connected registration controller B 300 shown in FIG. 1 is located in the room B, the smart switches B and C 100 are also located in the room B. The trigger button 32 generates a trigger signal in response to user's pressing on it, and sends the trigger signal to the processor 35. The processor 35 controls the IR sender 33 to send a registration request to the gateway 200 via wires or wirelessly, and send an IR signal in response to the trigger signal. The smart switches 100 arranged in the room B can receive the IR signal. In this embodiment, the registration controller B 300 sends the registration request to the gateway 200 via the power line 2 in response to the trigger signal. The IR signal includes the UID of the registration controller B 300, the UID of the gateway 200, and the secret code sent by the gateway 200. The smart switches B and C 100 store the UID of the registration controller B 300 and the secret code contained in the IR signal into the first storage 10. The registration request includes the UID of the registration controller B 300 and UID of the gateway 200.

The smart switches 100 can be registered to the gateway in different ways. In a driven registration manner, the gateway 200 broadcasts a signal to all of the smart switches 100 connected on the power line for determining whether the smart switch 100 received the IR signal sent by the registration controller 300, in response to the received registration request. The smart switches 100 which did receive the IR signal sends an encoded registration code to the gateway 200 in wired or wireless manner, in response to the broadcast signal. In this embodiment, the smart switches 100 are registered on the gateway 200 in the driven registration manner.

In this example, the smart switches B and C 100 located in room B each send an encoded registration code to the gateway 200 in wired or wireless manner, in response to the broadcast signal. The smart switches B and C 100 can send their encoded registration codes to the gateway 200 via the power line. The registration code includes the UID of the smart switch 100 and the UID of the registration controller 300 stored in the first storage 10. If the smart switch 100 includes more than one socket, the registration code further includes the UID of each socket.

The gateway 200 decodes the registration code and determines whether or not the UID of the registration controller 300 contained in the registration code matches the UID of the registration controller 300 contained in the registration request; if yes, the gateway 200 stores the UID of the smart switch 100. In this way, the smart switch 100 is registered on the gateway 200, the gateway 200 can send control signals including the UID of the target smart switch 100, and the smart switch 100 determines whether the UID of the received control signal matches with the UID of itself, only the matching smart switch 100 can parse the control signals, thus creating a point-to-point communication between the gateway 200 and the smart switch 100.

In an embodiment, the converter unit 34 of the registration controller 300 is configured to receive the control signals from the power line 2 sent by the gateway 200 and convert the control signals. The IR sender 33 sends the converted control signals to the corresponding smart switch 100 to control the electronic device 3 connected on the smart switch 100.

In a forward registration manner, the smart switch 100 which receives the IR signal sends an encoded registration code to the gateway 200 directly, instead of the driven registration process mentioned before. The other registration processes in the forward registration manner are the same as those of the driven registration manner, and are not repeated here.

All the signals transmitted between the smart switches 100, the gateway 200, and the registration controller 300 via the power line 2 as mentioned in the disclosure, include the UID of the device which sends the signals and the UID of the device which receives the signals. Furthermore, a secret code is used to encode the signals transmitted between the smart switches 100, the gateway 200, and the registration controller 300 via the power line 2, and the secret code is stored in smart switches 100, the gateway 200, and the registration controller 300.

In an embodiment, the registration controller 300 has the same appearance and function of the smart switches 100, the difference between the registration controller 300 and the smart switches 100 is that the registration controller 300 further includes a trigger button 32 and an IR sender 33. The registration controller 300 not only serves to control the smart switches 100 to automatically register on the gateway 200, but also acts as a smart switch.

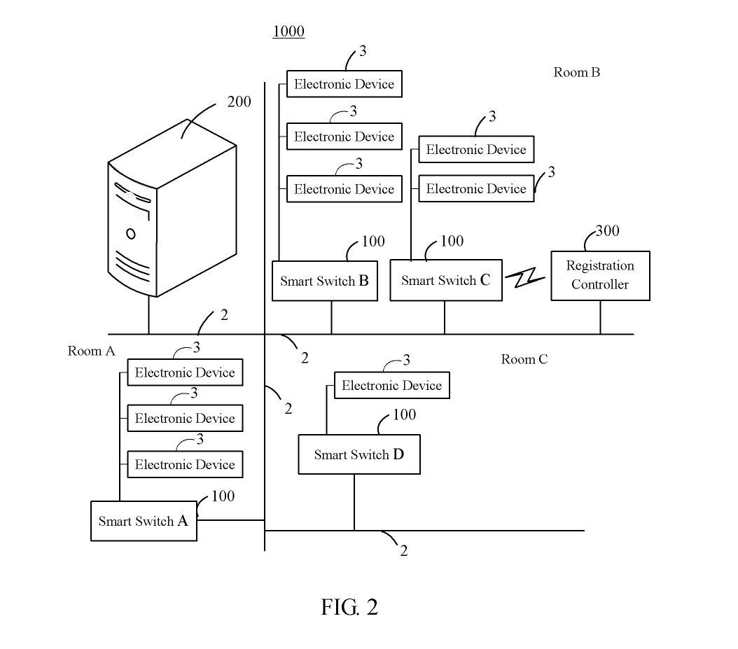

Referring to FIG. 2, in a second embodiment, only one registration controller 300 is employed in the smart control system 1000

The registration controller 300 is connected to the gateway 200, before the smart switches 100 register on the gateway 200, and the coupling process is the same as that of the first embodiment.

If user wants to register the smart switches 100 on the gateway 200, user should locate the connected registration controller 300 in the room in which smart switches 100 which need to be registered are located, and run a registering program on the mart gateway 200.

For example, the connected registration controller 300 shown in FIG. 2 is located in the room B, the smart switches B and C 100 are also located in the room B. The trigger button 32 generates a trigger signal in response of user's pressing on it, and sends the trigger signal to the processor 35. The processor 35 controls the registration controller 300 to send a registration request to the gateway 200 via wire connection or wireless connection. In this embodiment, the registration controller 300 sends the registration request to the gateway 200 via the power line 2 in response to the trigger signal. The gateway 200 generates a serial code and sends the serial code to the registration controller 300 via wires or wirelessly, in response to the registration request. In this embodiment, the gateway 200 sends the serial code to the registration controller 300 via the power line 2. The serial codes generated by the gateway 200 responding to the registration request are different each time, in this embodiment, the serial codes are generated according to the timestamp of the received registration request. For example, the first time the gateway 200 receives the registration request, the gateway 200 generates a first serial code, such as 01; the second time the gateway 200 receives the registration request, the gateway 200 generates a second serial code, such as 02.

The processor 35 of the registration controller 300 controls the IR sender 33 to send an IR signal in response to the received serial code, the IR signal includes the serial code, the UID of the registration controller 300, the UID of the gateway 200 and the secret code sent by the gateway 200. The smart switches B and C 100 can receive the IR signal. The smart switches B and C 100 store the serial code, the UID of the registration controller 300, and the secret code contained in the IR signal into the first storage 10.

The gateway 200 further broadcasts a signal to all of the smart switches 100 connected on the power line for determining whether the smart switch 100 has received the IR signal sent by the registration controller 300. The smart switches 100 which receive the IR signal sends an encoded registration code to the gateway 200 via the power line 2, in response to the broadcast signal. In this embodiment, the smart switches 100 are registered on the gateway 200 in a driven registration manner.

In this embodiment, the smart switches B and C 100 arranged in room B send the encoded registration code to the gateway 200 in response to the broadcast signal.

The registration code includes the serial code, the UID of the smart switch 100, and the UID of the registration controller 300 stored in the first storage 10. If the smart switch 100 includes more than one socket, the registration code further includes the UID of each socket.

The gateway 200 decodes the registration code and determines whether the

UID of the registration controller 300 contained in the registration code matches the UID of the registration controller 300 contained in the registration request, and if yes, the gateway 200 stores the UID of the registration code. In this way, the smart switch 100 is registered on the gateway 200, the gateway 200 can send control signals including the UID of the target smart switch 100, and the smart switch 100 determines whether the UID of the received control signal matches with its own UID, only the matching smart switch 100 can parse the control signals, thus creating a point-to-point communication between the gateway 200 and the smart switch 100.

Also, the smart switches 100 can be registered on the gateway 200 in a forward registration manner, the smart switch 100 which receives the IR signal sends an encoded registration code to the gateway 200 directly, and the other registration processes in the forward registration manner are the same those of the driven registration manner, and are not repeated here.

After registering the smart switches 100 on the gateway 200, the gateway 200 is capable of sending a controlling signal to the smart switches 100, to control the electronic devices 3 connected to the smart switch 100.

The disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A smart switch applied to a smart home system, the smart switch comprising:
at least one socket configured to connect an electronic device;
a plug configured to connect the smart switch to an power;
a storage configured to store an one-to-one relationship between unique identification codes of the electronic devices and names of the electronic devices, and one-to-one relationships between voice commands and remote control commands;
a voice input unit configured to receive sounds made by a user, and convert the sounds of the user to electronic data;
a remote controlling unit; and
a processor unit comprising a voice identifying module, a determining module, and a control module;
wherein the voice identifying module identifies the electronic data, and extracts a voice command and the name of the target electronic device;
wherein the determining module obtains the unique identification code of the target electronic device according to the one-to-one relationship between unique identification codes of the electronic devices and names of the electronic devices, and obtains the remote control command corresponding to the extracted voice command according to the one-to-one relationships between the voice commands and the remote control commands; and
wherein the control module controls the remote controlling unit to send the remote control command to the target electronic device.

2. The smart switch as described in claim 1, further comprising a voice output unit, wherein the determining module further determines whether a same voice command is stored in the first storage compared with the extracted voice command, if not, the control module controls the voice output unit to output a first sound to prompt users that the smart switch can not recognize the voice command.

3. The smart switch as described in claim 1, wherein the smart switch is communicated with a registration controller and a gateway, the smart switch further comprises:
a wireless receiver configured to receive wireless signals sent by the registration controller;
a Power Line Communication (PLC) or Optical Fiber Power Line Communication (OPLC) modern unit configured to establish communication between the smart switch and the gateway;
the processor unit stores the wireless signal in the storage and generates a registration code, the PLC or OPLC modern unit encodes the registration code and loads the encoded registration code to the power line to be transmitted to the gateway, the registration code comprises a unique identification code of the smart switch and a unique identification code of the registration controller.

4. The smart switch as described in claim 3, wherein remote controlling unit is an Infrared remote, a ZIGBEE remote, a Z-WAVE remote or a BLUETOOTH remote.

5. A smart control system comprising at least one smart switch, the smart switch connecting to a power and at least one electronic device, the smart switch comprising:
a storage configured to store one-to-one relationship between unique identification codes of the electronic devices and names of the electronic devices, and one-to-one relationships between voice commands and remote control commands
a voice input unit configured to receive sounds made by a user, and convert the sounds of the user to electronic data;
a remote controlling unit; and
a processor unit comprising a voice identifying module, a determining module, and a control module;
wherein the voice identifying module identifies the electronic data, and extracts the voice command and the name of the target electronic device;
wherein the determining module obtains the unique identification code of the target electronic device according the one-to-one relationship between unique identification codes of the electronic devices and names of the electronic devices, and obtains the remote control command corresponding to the extracted voice command according the one-to-one relationships between the voice commands and the remote control commands;
wherein the control module controls the remote controlling unit to send the remote control command to the target electronic device; and
wherein the electronic device executes a corresponding operation according to the remote control command.

6. The smart control system as described in claim 5, wherein the smart switch further comprises a voice output unit, the determining module further determines whether a same voice command is stored in the first storage compared with the extracted voice command, if not, the control module controls the voice output unit to output a first sound to prompt users that the smart switch can not recognize the voice command.

7. The smart control system as described in claim 5, further comprising a registration controller and a gateway, wherein the smart switch is communicated with a registration controller and a gateway, the gateway sends an identification code of the gateway and a secret code to the registration controller when the registration controller is located within the communicating range of the smart gateway and a mating program is run on the gateway, and the registration controller further send a unique identification code of the registration controller to the gateway.

8. The smart control system as described in claim 7, wherein the secret code is the identification code of the gateway or input by a user.

9. The smart control system as described in claim 7, wherein the registration controller comprises:
a second Infrared receiver configured to receive the identification code of the gateway and the secret code sent by the gateway;
a trigger button configured to generate a trigger signal in response of the user's pressing;
an Infrared sender; and
a processor configured to control the Infrared sender to send an Infrared signal comprising the identification code of the registration controller and the secret code, and control the registration controller to send a registering request to the gateway;
the smart switch further comprises a first Infrared receiver configured to receive the Infrared signal and a storage configured to save the Infrared signal, the smart switch further sends a registration code encoded by the secret code to the smart gateway, the registration code comprises the identification code of the smart switch and the identification code of the registration controller;
the gateway decodes the registration code and saves the identification code of the registration controller.

10. The smart control system as described in claim 7, wherein the gateway sends a broadcasting signal to the smart switch in response of the received registration request, the smart switch which has received the Infrared signal sends the registration code to the smart gateway in response of the broadcasting signal.

11. The smart control system as described in claim 7, wherein the smart switch comprises a socket, the registration code further comprises a unique identification code of the socket.

12. The smart control system as described in claim 5, wherein remote controlling unit is an Infrared remote, a ZIGBEE remote, a Z-WAVE remote or a BLUETOOTH remote.
